(19) United States
(12) Patent Application Publication
(10) Pub. No.: US 2023/0346631 A1
(43) Pub. Date: Nov. 2, 2023

(54) SEX TOYS SYSTEM AND METHOD

(71) Applicants: ZEEV SILES, HAIFA (IL); DAVID METSER, MODIIN (IL)

(72) Inventors: ZEEV SILES, HAIFA (IL); DAVID METSER, MODIIN (IL)

(21) Appl. No.: 18/197,210

(22) Filed: May 15, 2023

Related U.S. Application Data
(63) Continuation-in-part of application No. 16/950,931, filed on Nov. 18, 2020.

(30) Foreign Application Priority Data
Jan. 2, 2020 (IL) 271822

(51) Int. Cl. A61H 19/00; H04N 21/422; H04N 21/218; H04N 21/235

(52) U.S. Cl. CPC A61H 19/00; H04N 21/42203; H04N 21/218; H04N 21/235; A61H 2201/5043; A61H 2201/5097; A61H 2201/5012; A61H 2201/5048; A61H 2230/06

(57) ABSTRACT

A sex toys system having an application program to be executed on a user terminal, the application program being adapted to (a) display a movie received from a movie server over the internet, and (b) propagate a command, over a short-range wireless communication channel, to a sex toy, to be executed by the sex toy at a predefined time of the movie, where the movie server and the commands file server are separate entities.

### TECHNICAL FIELD

The invention relates to the field of remote sex entertainment.

### BACKGROUND

The term “sex toy” is defined by Wikipedia as “an object or device that is primarily used to facilitate human sexual pleasure, such as a dildo or vibrator. Many popular sex toys are designed to resemble human genitals and may be vibrating or non-vibrating. The term sex toy can also include BDSM apparatus and sex furniture such as slings.” (From Wikipedia) In this patent application, the term sex toy includes any device connected directly or indirectly to a sex act, including lights for providing a romantic atmosphere and the like.

The term “remote sex toy” refers herein to a sex toy operated by commands transmitted over a wide area network (such as the Internet) by a remote user. For example, a first user controls the operation of a sex toy of a second user over the internet.

Presently, remote sex toys are well known. For example, https://www.youtube.com/watch?v=w3oOm8Qhdm4 presents an operation of such devices, and https://www.lovense.com/public/store presents products in this area.

FIG. 1 schematically illustrates data flow in a sex toys system, according to the prior art.

A first user uses an application program (not shown) executed on a first smartphone 11 to activate a sex toy 15 at the side of a second user which executes a corresponding application program on a second smartphone 12.

The communication between the application programs is carried out via a wide area network 13 such as the internet.

At the second user side, the smartphone 12 communicates with the sex toys 15 via a short-range wireless communication, such as Bluetooth, and instructs the sex toys 15 to change their operation mode, speed (e.g., vibration), and so on.

It should be noted that as of today the application software does not include movie display but only buttons, check boxes, menus etc. Of course, the users may see each other via a movie chat application, but there is no embedded means in dedicated application programs for displaying a movie.

The use of remote sex toys has become popular in the recent years. This indicates that there is a continuing need to enhance sexual experience through sex toys.

### SUMMARY

In one aspect, the invention is directed to a sex toys system, comprising an application program to be executed on a user terminal, the application program being adapted to (a) display a movie received from a movie server (i.e., a server that store movie files) over the internet, and (b) propagate a command, over a short-range wireless communication channel, to a sex toy, to be executed by the sex toy at a predefined time of the movie, wherein the movie server and the commands file server (i.e., a server that stores commands files for sex toys) are separate entities (i.e., they are not stored on the same server).

The separated servers allow using the movie along with the commands file without using an SDK (Software Development Kit) and the like from the movie owner.

The system may further comprise a commands file editor, for defining (a) a time of said movie to execute said command, and (b) operation parameters of said command, wherein said commands file editor is executed on a different computing entity than said movie server.

In this case also the separated servers allow using the movie along with the commands file editor without using an SDK (Software Development Kit) and the like from the movie owner.

The system may further comprise a user interface for changing an operation of the sex toy. Such operation may be its duration, its intensity, etc.

According to embodiments of the invention, the movie comprises a unique ID for associating thereto a commands file.

According to embodiments of the invention, an input of the user interface is carried out by speaking. For example, a user may say “halt” to abort any operation of a sex toy, “increase” to increase its velocity, and so on.

The sex toy may be handcuffs, a shocker, a heart tracker, a light, a fan, water splashier, a sprayer, a sex chair, a sex padlock, a safety box, a longitudinal vibrator, a sex padlock, and a chastity belt.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments, features, and aspects of the invention are described herein in conjunction with the following drawings, in which:

FIG. 1 schematically illustrates data flow in a sex toys system, according to the prior art;

FIG. 2 schematically illustrates data flow in a sex toys system, according to one embodiment of the invention;

FIG. 3 schematically illustrates a user interface of a sex toys system, according to one embodiment of the invention;

FIG. 4 schematically illustrates data flow in a sex toys system, according to a further embodiment of the invention;

FIG. 5 schematically illustrates data flow in a sex toys system, according to a yet further embodiment of the invention;

FIG. 6 is a block diagram schematically illustrating data flow in a sex toys system, according to one embodiment of the invention; and

FIG. 7 is a block diagram schematically illustrating data flow in a sex toys system, according a further embodiment of the invention.

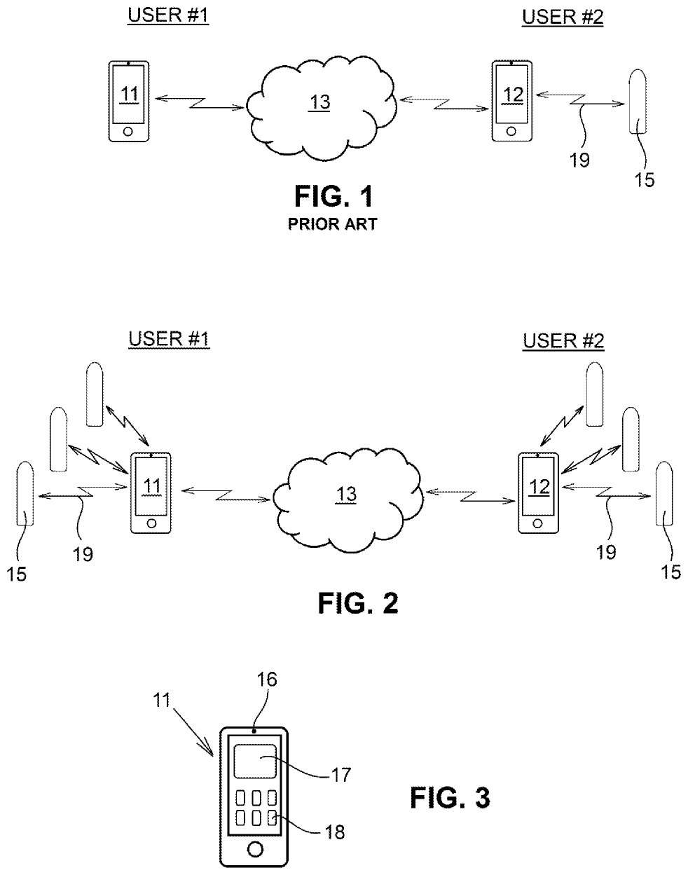

It should be understood that the drawings are not necessarily drawn to scale.

### DETAILED DESCRIPTION

The invention will be understood from the following detailed description of embodiments which are meant to be descriptive and not limiting. For the sake of brevity, some well-known features, methods, systems, procedures, components, circuits, and so on, are not described in detail.

FIG. 2 schematically illustrates data flow in a sex toys system, according to one embodiment of the invention.

FIG. 3 schematically illustrates a user interface of a sex toys system, according to one embodiment of the invention.

At each side (of a user the) the application program (not illustrated) uses the camera 16 of his smartphone for photographing live movie of the user, and transmitting it to the smartphone of the remote user. Thus, the user interface of each user includes a movie 17 of the movie photographing of the remote user. In addition, the user interface also includes operation buttons 18, by which the user may activate and deactivate a sex toy 15 of the remote user, change its operation mode, increase and decrease its vibration rate and/or velocity, etc.

Commands for changing the mode of operation (on, off, velocity, vibration rate, etc.) of the sex toys of the remote user are transmitted also via the communication channels.

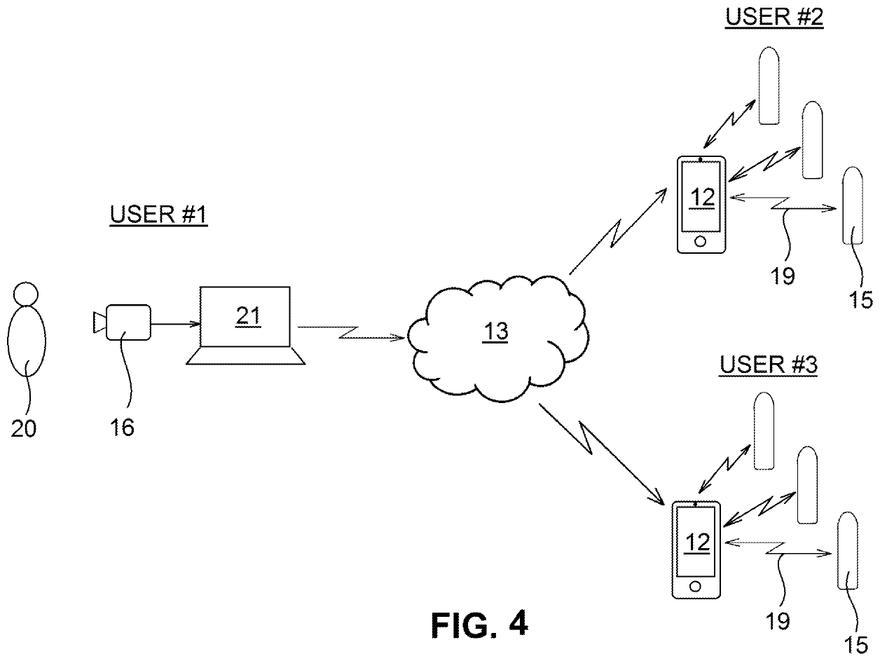

FIG. 4 schematically illustrates data flow in a sex toys system, according to a further embodiment of the invention.

At the side of the first user is installed a camera 16, which transmits via computer 21 live movie including commands to sex toys to a plurality of users, each having his own sec toys.

This arrangement can be carried out using a web site (not shown). Each of the users connects to the web site via his smartphone or computer (not shown), and watches the show while his sex toys are controlled by signals sent from the first user.

The commands to the sex toys may be sent by the performer (user 20), by a human assistant (not illustrated), by voice commands or by a device or application program in which the operation of the remote sex toys can be changed (e.g., changing the vibration rate of a vibrator).

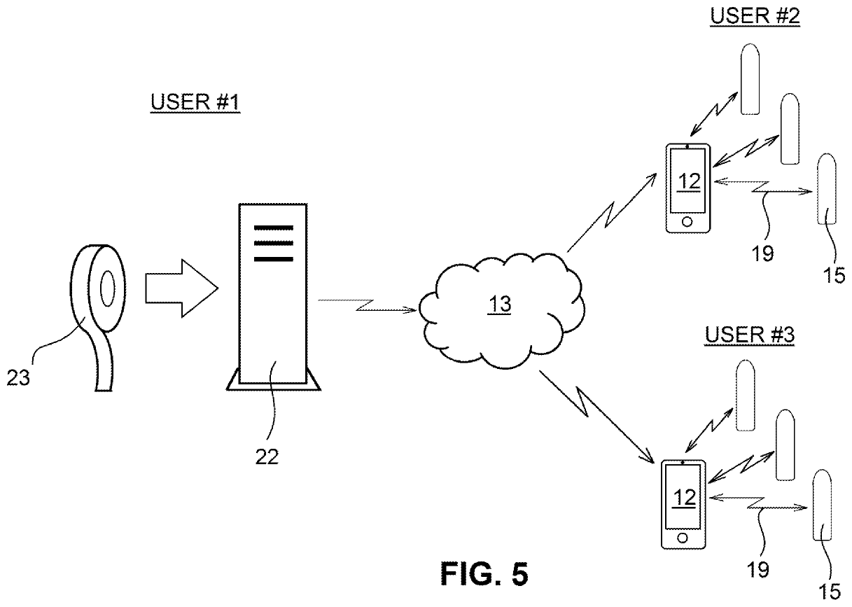

FIG. 5 schematically illustrates data flow in a sex toys system, according to yet a further embodiment of the invention.

A web server 22, which provides web services, runs a web site in which its users can watch a sex movie 23 while the sex toys 15 of each user are provided with commands to his sex toys, synchronized with the movie.

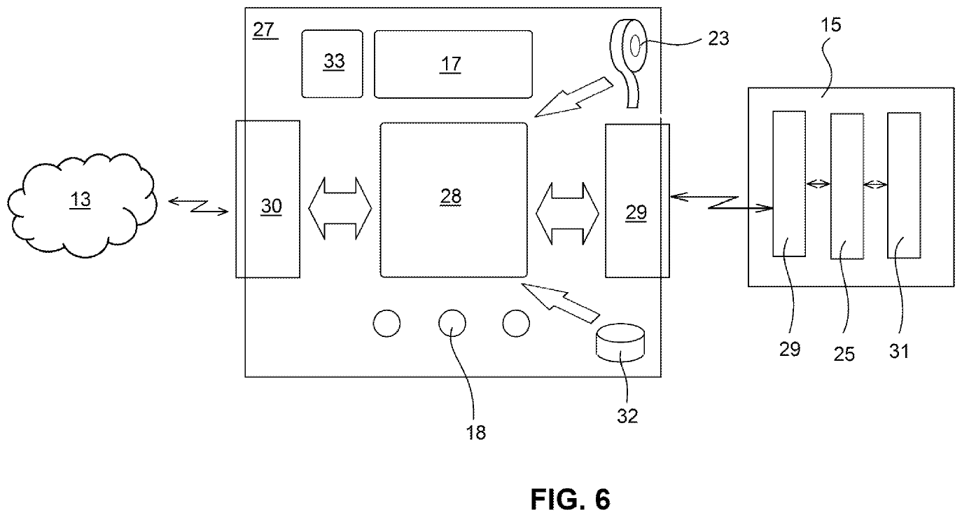

FIG. 6 is a block diagram schematically illustrating data flow in a sex toys system, according to one embodiment of the invention.

The “heart” of the system is a user terminal 27, which interacts with one or more remote sex toys 15. The user terminal may be any computerized facility, such as a desktop computer, a smartphone, etc.

The user terminal 27 comprises a display 17 for displaying a sex movie. While displaying the sex movie, the user terminal sends operation commands to the sex toys over a short-range wireless communication channel, such as Bluetooth. The operation schedule of the sex toys corresponds to the contents on the movies, such as increasing or decreasing a vibration rate and intensity of a sex toy 15 at a certain moment of the movie.

The sex movie can reside on the user terminal 27 (e.g., a movie file), or can be transmitted from a remote site to the user terminal over a wide area network such as the internet, while being played on the user terminal (“streaming”).

In addition, the movie signal of the movie can bear scheduled commands to the sex toys, which are propagated to the sex toys 15 at the scheduled times. Alternatively, a scheduled commands file can be used. The scheduled commands file can reside on the user terminal or can be transmitted to the user terminal from the remote location along with the movie signal.

### Sex Toys Commands File

When displaying a movie (in contrast to a live movie), a schedule of operating the remote sex toys have to be set. For example, at a certain time point a certain sex toy has to be activated, at another time point a certain sex toy has to be deactivated, its velocity has to be increased (for example by 10%), etc. This time schedule has to be recorded somewhere and transmitted to the remote user terminals.

One way to transfer a list of commands to a remote user terminal is through a commands file. A command in such a file may contain information such as the sex toy type (vibrator, lust eggs, light, padlock, shocker, steps tracker band with heart rate tracker, etc.), operation type (e.g., turn on, turn off, vibrate, cease gradually, etc.), operation intensity, duration, the time from the beginning of the movie to activate this operation, etc. The application program on a user terminal (smartphone, computer, etc.) at the remote user side gets the commands file, and while playing the corresponding movie, at the scheduled time of a command it sends the operation instruction of this command to the corresponding sex toy via short-range transmission such as Bluetooth.

Another way to transfer commands to a user terminal at the remote side is through an audio file, or audio part of a movie file. Since the human ear cannot hear all the frequencies, some bits of an audio file can be used in an audio file to transfer commands. Assuming at any given moment on a movie file there are 5 bits usable as a command for sex toys, then 2 bits (for example) can be used to identify the sex toy type (vibrator, lust eggs, light, etc.), and the other bits can be used to set the intensity operation. The location on the sound file determines the time the operation will take place.

A commands file editor is an application program for determining a set of commands to a sex toy, a time of a movie in which the sex toy is activated, for how long, at which velocity, increasingly or decreasingly, etc.

Such program may graphically present the time line from the beginning of a movie, when a sex toy starts to operate, for how long, its intensity, and so on.

According to embodiments of the invention, the movie is not stored in the computing apparatus which runs the commands file editor, but rather is played while being downloaded from a remote server over the internet. A user stops the play at any desired moment, and inserts a command to a sex toy and its operation parameters. The commands can be stored on a file.

It should be emphasized that the internet server that stores the commands file is independent from the internet server that stores the movie file. Thus, by using the invention one can create a commands file independently from the movie server (i.e., on a separate computing machine) so that no SDK (Software Development Kit) and the like from the movie owner is required.

In other words, although a movie can be downloaded from the movie server to the computing device (desktop computer, smartphone, etc.) on which the commands file editor runs, according to the invention the best mode of operation is displaying the movie rather than downloading it, since downloading a file may violate a license thereof.

### Data Architecture

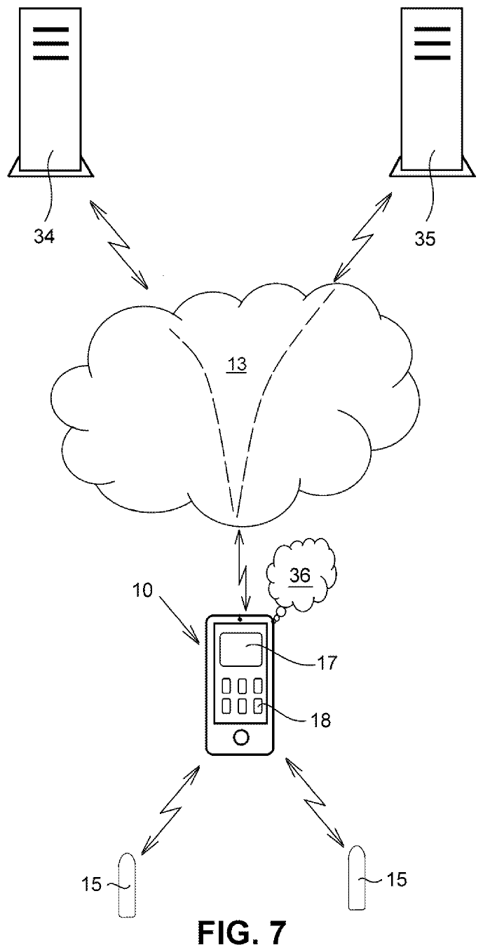

FIG. 7 is a block diagram schematically illustrating data flow in a sex toys system, according a further embodiment of the invention.

According to this embodiment of the invention, two separate servers are used: a movie server 34, which stores the movie (movie) files, and a toy command server 35, which stores the commands file related to these movies. Thus, when displaying a movie, e.g., of Youtube, the commands thereof are downloaded to the user terminal 10 from the remote server 35, and activated along with displaying the movie on the user terminal 10.

Preferably, each movie is associated with a unique ID. The ID is used for associating a commands file with a certain movie.

This data architecture allows a user to watch a movie along with sex toy activation independently from the movie maker or distributor.

This data architecture allows a user to edit create a commands file of a movie without downloading the movie to his computer, but rather displaying the movie.

### Sex Toys

Some sex toys may be more sophisticated than a vibrator. The following are several examples thereof (that are controlled by a user terminal via short-range wireless communication such as Bluetooth):

Lust eggs according to embodiments of the invention are actually a pair of vibrators, each vibrating in all directions.

Handcuffs are an apparatus in a form of handcuffs which the opening and closing thereof is controlled by a user terminal.

Shocker is an apparatus which is worn, for example, on a neck of a user, and controlled by a user terminal.

A heart rate tracker is a device that may be worn on a wrist of a user. The device measures the user's heart rate, and activates other sex toys (such as a shocker) to operate in this rate.

A chastity belt is a well-known device. However, a chastity belt controlled by a user terminal 10 via short-range wireless communication such as Bluetooth is novel.

A padlock is a lock which closes and opens by commands from a user terminal via short-range wireless communication such as via Bluetooth communication. Its purpose is to lock and unlock a sex toy.

A safety box is a box that closes and opens by commands from a user terminal.

An atmosphere light is a device that lights in a variety of colors by commands from a user terminal 10. It is useful for creating a desired atmosphere.

Presently a sex vibrator is well-known. It is an elongated device that contains a mechanism that vibrates it horizontally (i.e., in 90 degrees to its longitudinal axis). A Longitudinal Sex Vibrator according to embodiments of the invention is a sex vibrator that vibrates longitudinally rather than horizontally as in the prior art.

A fan is a fan activated and deactivated by a command from a user terminal.

A Liquid Splashier is a device that splashes liquid drops as a result of a command from a user terminal.

A sprayer is a device that sprays as a result of the command from a user terminal.

A Sex Chair is a chair adapted to sexual activity, which receives operating instructions from a user terminal.

All these examples use Bluetooth communication, but Bluetooth is merely an example and other short range communication protocols can be employed.

In addition to commands to sex toys of a commands file, the user terminal may be adapted to provide commands to sex toys by the user. Such commands may be increasing the operation rate of a sex toy, halting any operation of sex toys, etc.

According to a further embodiment of the invention, the sex toys can be operated by audio interface. For example, the user can say “HALT” in order to cease the operation of all the activated sex toys. He may also use commands such as “increase vibration”, “stop splashing”, and so on.

In the figures and/or description herein, the following reference numerals (Reference Signs List) have been mentioned:
Numeral 10 denotes a user terminal (a computerized device) such as a computer and a smartphone;
numeral 11 denotes a smartphone of a first user;
numeral 12 denotes a smartphone of a second user (a remote user);
numeral 13 denotes a wide area network, such as the internet, telephony network, etc.;
numeral 14 denotes a movie source;
numeral 15 denotes a sex toy;
numeral 16 denotes a camera;
numeral 17 denotes a display;
numeral 18 denotes operation buttons;
numeral 19 denotes a short-range wireless communication, such as Bluetooth;
numeral 20 denotes a user;
numeral 21 denotes a computer;
numeral 22 denotes a web server;
numeral 23 denotes a movie file;
numeral 24 denotes a communication module;
numeral 25 denotes a controller;
numeral 26 denotes a hardware mechanism;
numeral 27 denotes a user terminal;
numeral 28 denotes an application program;
numeral 29 denotes a short-range communication module;
numeral 30 denotes a long distance communication module;
numeral 31 denotes a sex toy mechanical module;
numeral 32 denotes a scheduled commands file for sex toy(s);
numeral 33 denotes a speaker;
numeral 34 denotes a movie server (i.e., the movie);
numeral 35 denotes a commands file server; and
numeral 36 denotes a commands file editor.

In the text herein, the following terms have been mentioned:

Wide Area Network (WAN) Wide Area Network refers to a large network that uses high-speed lines, switches, and routers. It connects to LANs at router point.

Local Area Network (LAN) is an interconnected system of computers and peripherals, LAN users share data stored on hard disks and can share printers connected to the network. A general term for large networks using high speed lines, switches, and routers. It connects to LANs at router point.

“A Web server is a program that uses HTTP (Hypertext Transfer Protocol) to serve the files that form Web pages to users, in response to their requests, which are forwarded by their computers' HTTP clients. Dedicated computers and appliances may be referred to as Web servers as well.” (From whatis.com)

The term Bluetooth refers in the art to a wireless technology standard used for exchanging data between devices over short-ranges using short-wavelength UHF radio waves. Bluetooth is managed by the Bluetooth Special Interest Group (SIG).

The term “short-range wireless communication channel” refers herein to a wireless communication channel over a distance of at least 5 meters. Examples of short-range communication protocols are Bluetooth, IEEE 802.11, ultra-wideband (UWB), shared wireless access protocol (SWAP), digital enhanced cordless telecommunications (DECT), GSM, UMTS, CDMA, WCDMA, IRDA (infrared data association) protocols, CDMA2000, time-division CDMA (TD-CDMA), HiperLAN2, HomeRF, or wide band frequency hopping (WBFH).

The term “Voice User Interface” (VUI) is the term used to describe the interaction with a computerized mechanism through a voice/speech platform in order to initiate an automated service or process.

The foregoing description and illustrations of the embodiments of the invention has been presented for the purposes of illustration. It is not intended to be exhaustive or to limit the invention to the above description in any form.

Any term that has been defined above and used in the claims should be interpreted according to this definition.

What is claimed is:

1. A sex toys system, comprising:
an application program to be executed on a user terminal, said application program being adapted to
(a) display a movie received from a movie server over the internet, and
(b) propagate a command, over a short-range wireless communication channel, to a sex toy, to be executed by said sex toy at a predefined time of said movie,
wherein said movie server and said commands file server are separate entities.

2. A system according to claim 1, further comprising:
a commands file editor, for defining
(a) a time of said movie to execute said command, and
(b) operation parameters of said command,
wherein said commands file editor is executed on a different computing entity than said movie server.

3. A system according to claim 1, further comprising a user interface for changing an operation of said sex toy.

4. A system according to claim 3, wherein an input of said user interface is carried out by speaking.

5. A system according to claim 1, wherein said movie comprises a unique ID for associating thereto a commands file.

6. A system according to claim 1, wherein said sex toy is handcuffs.

7. A system according to claim 1, wherein said sex toy is a shocker.

8. A system according to claim 1, wherein said sex toy is a heart tracker, to be embedded within an operation of another sex toy.

9. A system according to claim 1, wherein said sex toy is an atmosphere light.

10. A system according to claim 1, wherein said sex toy is a fan.

11. A system according to claim 1, wherein said sex toy is a liquid splashier.

12. A system according to claim 1, wherein said sex toy is a sprayer.

13. A system according to claim 1, wherein said sex toy is a sex chair.

14. A system according to claim 1, wherein said sex toy is a padlock.

15. A system according to claim 1, wherein said sex toy is a safety box.

16. A system according to claim 1, wherein said sex toy is a chastity belt.
